(19) United States
(12) Patent Application Publication
(10) Pub. No.: US 2026/0312476 A1
(43) Pub. Date: Oct. 8, 2026

(54) FLUX REVERSING MOTOR ASSEMBLIES INCLUDING INNER STATOR ASSEMBLIES

(71) Applicant: Regal Beloit America, Inc., Milwaukee, WI (US)

(72) Inventors: Greg Heins, Melbourne (AU); Benjamin Robinson, Melbourne (AU); Mark Thiele, Melbourne (AU)

(21) Appl. No.: 19/170,174

(22) Filed: Apr. 4, 2025

(51) Int. Cl. H02K 21/10

(52) U.S. Cl. CPC H02K 21/10

(57) ABSTRACT

Embodiments of the present disclosure are directed to a flux reversing motor assembly including a rotor core of a rotor assembly including a plurality of magnets positioned within a rotor support structure, and a modulator surrounding the rotor core. The modulator includes a plurality of modulator subteeth extending radially toward said rotor core. The motor assembly also includes a stator assembly radially inward from the rotor assembly and including a stator radially inward from and adjacent the rotor core. The stator includes a plurality of arm portions extending radially from an inner portion of the stator, and a plurality of outer portions radially opposite the inner portion, and adjacent the rotor core. Each of the plurality of outer portions are disposed directly adjacent one of the plurality of arm portions and include a plurality of stator subteeth.

### BACKGROUND

The field of the disclosure relates generally to motor systems, and more particularly, to flux reversing motor assemblies including inner stator assemblies and outer rotor assemblies.

Radial flux electric machines such as motors or generators generally include spoked permanent magnets positioned within a rotor core. The rotor core is formed from multiple laminations. The laminations define circumferentially spaced poles within the rotor core. Alternatively, the poles may comprise discrete members supported by the rotor. In the alternate rotor, slots are formed between adjacent poles, and spoke magnets are disposed in the slots. To further increase the efficiency of the motor, and prevent flux from leaking across laminations, the rotor can include axial magnets positioned adjacent the ends of the spoked rotor magnets.

In radial flux electric machines, such as electric motors and generators, a stator is positioned proximate the rotor. During use, the stator is stationary while the rotor rotates relative to the stator. The stator may be located at the rotor outer periphery. The stator comprises a combination of a laminated core and coils of insulated wire referred to as windings. When alternating current is applied to stator windings, a magnetic field is created that produces the desired rotor rotation, thereby producing the associated motor power.

To increase the motor torque rating in known electric motors, the size of the coil windings may be increased. The size/extent of the coils may be increased by expanding the diameter of the coil wires or the number of windings may be increased. The larger coil size and geometry generates greater electrical loadings which produce greater motor power. In such a motor, the coil size/increased windings may be increased without modifying the geometry/configuration of motor assembly or motor components. Known motor designs allow for the use of larger diameter coils without having to proportionately increase the size of the rotor assembly.

Such electrical motors are typically symmetric relative to the stator opening or rotor shaft or axis of rotation. E.g., with windings diametrically opposed on opposite stator sides. Although the torque of an electric motor with symmetric configuration can be increased by adjusting the coil characteristics, the torque increase is limited by at least the volume available to house the increased coil windings and the symmetric configuration. Typically, in use, it is preferred that the motor footprint remain constant to ensure the assembly fits within the system within which the motor will be installed. The tendency to implement symmetric motors may serve as a design factor that limits the torque that may be produced by an electric motor. The need to maintain motor housing dimensions constant limits available internal volume for housing the conductors and thereby limits the size and extent of conductors that may be accommodated in a specific motor housing and may also serve to limit the electric motor torque output.

Thus, there is a need in the field for improved stator assemblies and rotor assemblies that enables motors to supply increased torque.

### BRIEF DESCRIPTION

In one embodiment, a flux reversing motor assembly is described. The flux reversing motor assembly includes a rotor assembly including a rotor core having a rotor support structure, and a plurality of magnets positioned within the rotor support structure. Each of the plurality of magnets are circumferentially spaced apart from one another within the rotor support structure. The flux reversing motor assembly also includes a modulator surrounding the rotor core of the rotor assembly. The modulator includes an inner surface disposed adjacent the rotor core, and a plurality of modulator subteeth extending radially from the inner surface and toward the rotor core of the rotor assembly. Within the rotor assembly, the rotor core is configured to rotate relative to the modulator.

In an additional embodiment, a stator assembly for use in a flux reversing motor assembly is described. The stator assembly includes a stator including an inner portion including an aperture extending axially there through, and a plurality of arm portions extending radially from the inner portion. Each of the plurality of arm portions circumferentially spaced from one another to form a plurality of openings. The stator also includes a plurality of outer portions radially opposite the inner portion. Each of the plurality of outer portions disposed directly adjacent one of the plurality of arm portions and including a plurality of stator subteeth. The stator assembly also includes a plurality of coils disposed within the plurality of openings of the stator. Each of the plurality of coils surrounding one of the plurality of arm portions of the stator, radially between the inner portion and the plurality of outer portions.

In another embodiment, a motor assembly is described. The motor assembly includes a rotor assembly including a rotor core including a plurality of magnets positioned within a rotor support structure. The motor assembly also includes a modulator surrounding the rotor core, and the modulator includes a plurality of modulator subteeth extending radially from an inner surface disposed adjacent the rotor core and extending radially toward the rotor core of the rotor assembly. The motor assembly also includes a stator assembly radially inward from the rotor assembly. The stator assembly includes a stator radially inward from and adjacent the rotor core of the rotor assembly. The stator includes a plurality of arm portions extending radially from an inner portion of the stator. Each of the plurality of arm portions circumferentially spaced from one another to form a plurality of openings. The stator also includes a plurality of outer portions radially opposite the inner portion, and adjacent the rotor core of the rotor assembly. Each of the plurality of outer portions are disposed directly adjacent one of the plurality of arm portions and include a plurality of stator subteeth. The rotor core is configured to rotate relative to the modulator and the stator.

### BRIEF DESCRIPTION OF THE DRAWINGS

FIG. 1 is a perspective view of a flux reversing motor assembly;

FIG. 2 is a perspective, exploded view of the flux reversing motor assembly shown in FIG. 1;

FIG. 3 is a front, cross-sectional view of a stator assembly of the flux reversing motor assembly taken along line CS-CS of FIG. 1;

FIG. 4 is an enlarged front, cross-sectional view of a portion of the stator assembly shown in FIG. 3;

FIG. 5 is a front, cross-sectional view of a rotor core of a rotor assembly and a modulator of the flux reversing motor assembly taken along line CS-CS of FIG. 1;

FIG. 6 is a front, cross-sectional view of the modulator shown in FIG. 5;

FIG. 7 is an enlarged front, cross-sectional view of a portion of the stator assembly, the rotor assembly, and the modulator of the flux reversing motor assembly shown FIGS. 1 and 2; and

FIG. 8 is a front, cross-sectional view of the stator assembly, the rotor assembly, and the modulator of the flux reversing motor assembly taken along line CS-CS of FIG. 1.

### DETAILED DESCRIPTION

As used herein, the singular forms “a,” “an,” and “the” include plural references unless the context clearly dictates otherwise. The terms “comprising,” “including,” and “having” are intended to be inclusive and mean that there may be additional elements other than the listed elements. The terms “optional” or “optionally” means that the subsequently described event or circumstance may or may not occur, and that the description includes instances where the event occurs and instances where it does not.

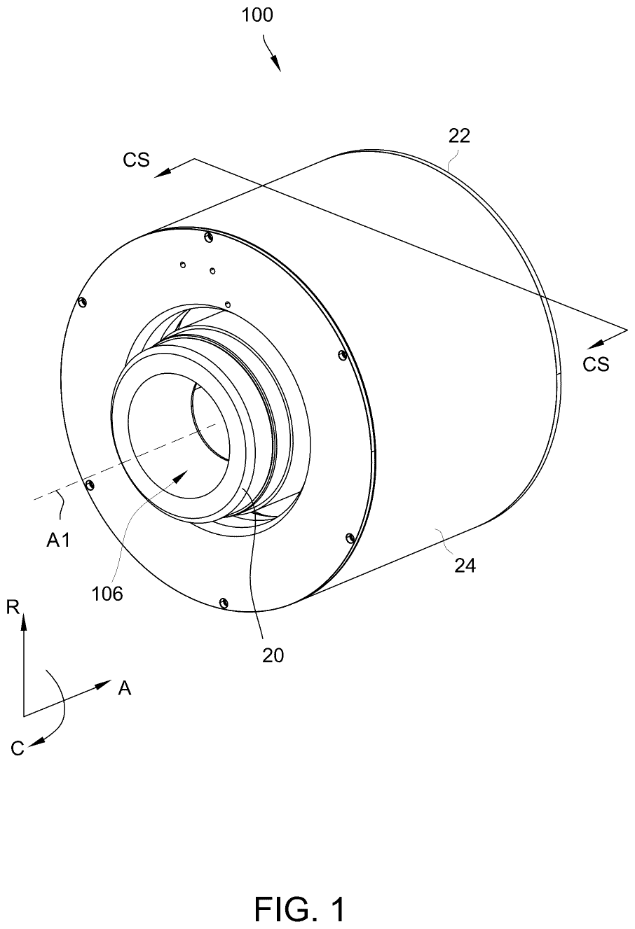

In addition, several descriptive terms may be used regularly herein, and it should prove helpful to define these terms at the onset of this section. These terms and their definitions, unless stated otherwise, are as follows. It is often required to describe parts that are at differing radial, axial and/or circumferential positions. The “A” axis represents an axial orientation. As used herein, the terms “axial” and/or “axially” refer to the relative position/direction of objects along axis A, which is substantially parallel with the shaft of the motor assembly, as discussed herein. As further used herein, the terms “radial” and/or “radially” refer to the relative position/direction of objects along a direction “R” (see, FIG. 1), which is substantially perpendicular with axis A and intersects axis A at only one location. Finally, the term “circumferential” refers to movement or position around axis A (e.g., direction “C”). In cases such as this, if a first component resides closer to the axis than a second component, it will be stated herein that the first component is “radially inward” of the second component. If, on the other hand, the first component resides further from the axis A than the second component, it may be stated herein that the first component is “radially outward” of the second component.

Embodiments of the present disclosure are directed to stator assemblies, rotor assemblies, and modulators for use in flux reversing motor assemblies. Rotor assemblies of the motor assemblies include a rotor core including a plurality of magnets positioned within a rotor support structure of the rotor. A modulator of the motor assemblies surrounds the rotor core and includes a plurality of modulator subteeth extending radially from an inner surface of the modulator, disposed adjacent the rotor core. Each of the plurality of modulator subteeth extend radially toward the rotor core of the rotor assemblies. Stator assemblies of the motor assemblies are positioned radially inward from the rotor assemblies and include a stator radially inward from and adjacent to the rotor core of the rotor assemblies. The stator includes a plurality of arm portions extending radially from an inner portion of the stator. Each of the plurality of arm portions are circumferentially spaced apart from one another to form a plurality of openings within the stator. The stator also includes a plurality of outer portions radially opposite the inner portion, and adjacent the rotor core of the rotor assemblies. Each of the plurality of outer portions are disposed directly adjacent one of the plurality of arm portions and include a plurality of stator subteeth that extend radially toward the rotor core of the rotor assemblies. During operation of the motor assemblies, the rotor core of the rotor assemblies is configured to rotate relative to the modulator of the rotor assemblies and the stator of the stator assemblies included therein.

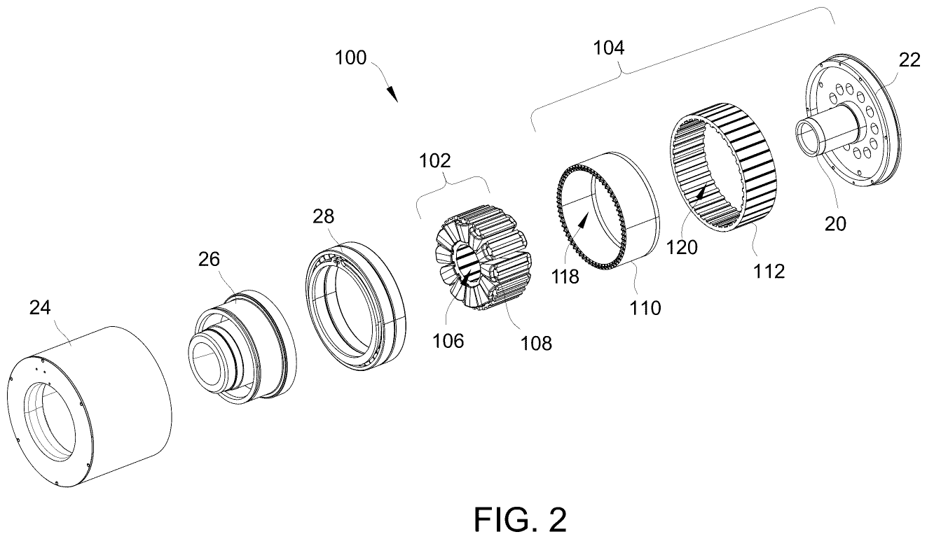

FIG. 1 is a perspective view of motor assembly 100, and FIG. 2 is an exploded, perspective view of motor assembly 100 shown in FIG. 1. In an exemplary embodiment, a larger motor system (not shown) receives and/or utilizes motor assembly 100 therein to provide an output (e.g., power, torque) to a drive component. That is, and as discussed herein, motor assembly 100 is connected to and/or in communication with a drive component configured to transfer and/or drive distinct components of additional devices and/or systems coupled to motor assembly 100. For example, motor assembly 100 is coupled to a belt drive (not shown) and utilizes the rotation and/or torque generated by motor assembly 100 to drive and/or move the belt drive during operation. As discussed herein, motor assembly 100 includes an inner stator assembly 102, a rotor assembly 104 circumscribing stator assembly 102, and a modulator 112 (see, FIG. 2).

Motor assembly 100 is formed as a flux reversing motor assembly. In the exemplary embodiment, motor assembly 100 includes a shaft 20 extending from an end plate 22 and disposed through a housing 24. Additionally, end plate 22 is coupled to and/or secured within at least one of housing 24 to support inner stator assembly 102 (see, FIG. 2) of motor assembly 100. For example, end plate 22 is coupled to housing 24, surrounding motor assembly 100. As discussed herein, shaft 20 extends axially through an aperture 106 formed through components of inner stator assembly 102. Shaft 20 of motor assembly 100 defines an axial axis A1 that extends the entirety of motor assembly 100 through aperture 106 included in stator assembly 102. Shaft 20 is also aligned with the axial axis A1.

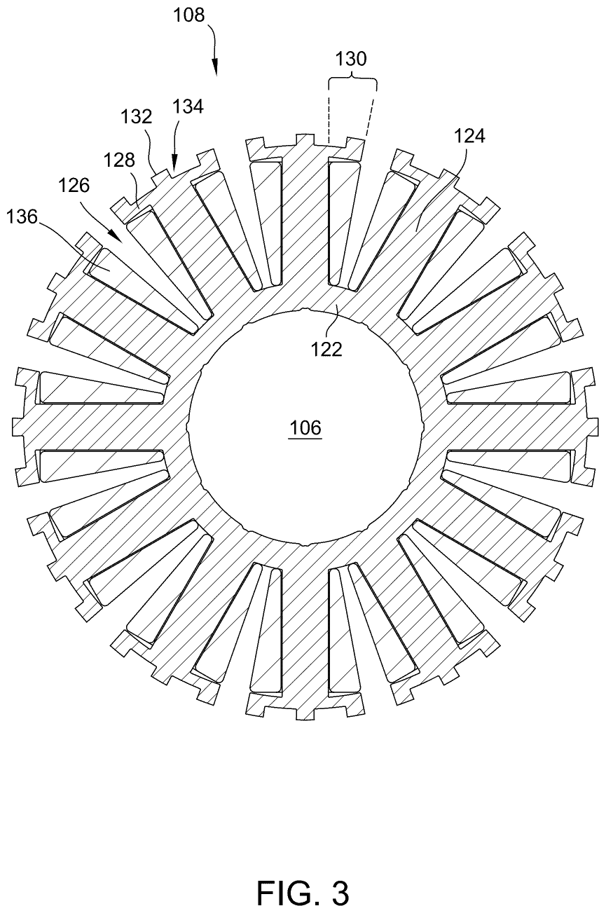

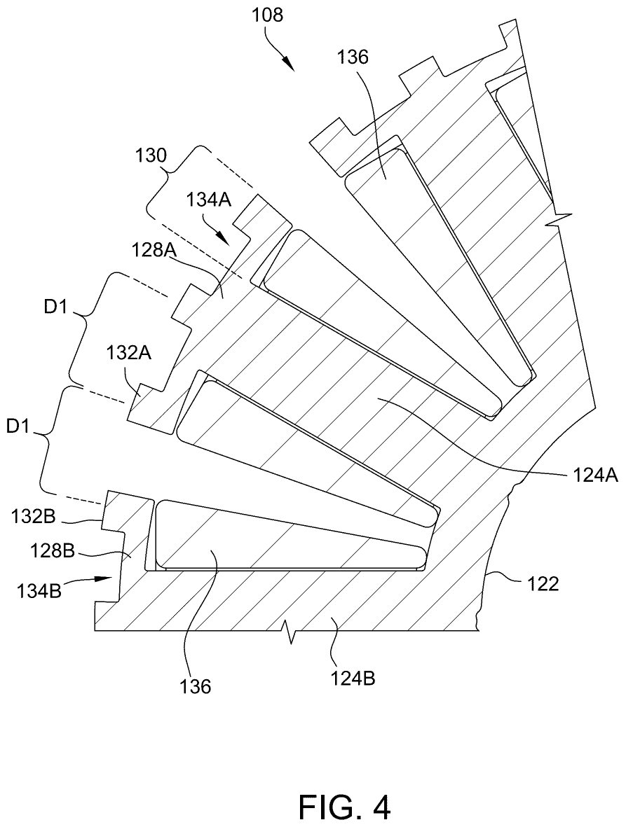

As shown in FIG. 2, stator assembly 102 of motor assembly 100 includes a stator assembly 102 including aperture 106 extending axially therethrough, where aperture 106 receives, is coupled to, and/or contacts shaft 20. Additionally, and as discussed herein, stator assembly 102 includes a plurality of coils (see, FIG. 3) extending axially through, substantially enveloping, and/or winding around portions of stator 108. Also as discussed herein (see, FIGS. 3 and 4), stator assembly 102 includes a plurality of distinct portions and/or sections configured to aid in the operation of motor assembly 100.

As shown in FIG. 2, and as discussed herein, rotor assembly 104 includes a rotor core 110 substantially surrounding, circumscribing, receiving, and/or encompassing stator assembly 102 via opening 118. During operation, rotor core 110 is configured to move relative to and/or rotate about stator assembly 102. Additionally, rotor core 110 is also configured to move and/or rotate relative to stationary modulator 112. Modulator 112 also includes a space 120 for receiving rotor core 110 of rotor assembly 104. As such, and as discussed herein, modulator 112 substantially surrounds, circumscribes, receives, rotor core 110. During operation of motor assembly 100, modulator 112 remains stationary and/or does not rotate along with rotor core 110, but rather remains stationary.

Motor assembly 100 also includes a distinct shaft 26 positioned within and at least partially extending through housing 24. Distinct shaft 26 is positioned within housing 24, adjacent to stator assembly 102 and rotor assembly 104, respectively. In non-limiting examples, distinct shaft 26 is coupled to rotor core 110 and is configured to rotate, along with rotor core 110 to transmit torque to a distinct component (not shown) coupled to and/or in communication with distinct shaft 26.

Additionally, motor assembly 100 includes bearing assemblies 28 disposed within housing 24. Bearing assemblies 28 are positioned on and/or substantially surround distinct shaft 26 within housing 24. During operation, bearing assemblies 28 are configured to facilitate the rotation of distinct shaft 26 and/or rotor core 110 of rotor assembly 104 independent from and/or within housing 24 of motor assembly 100.

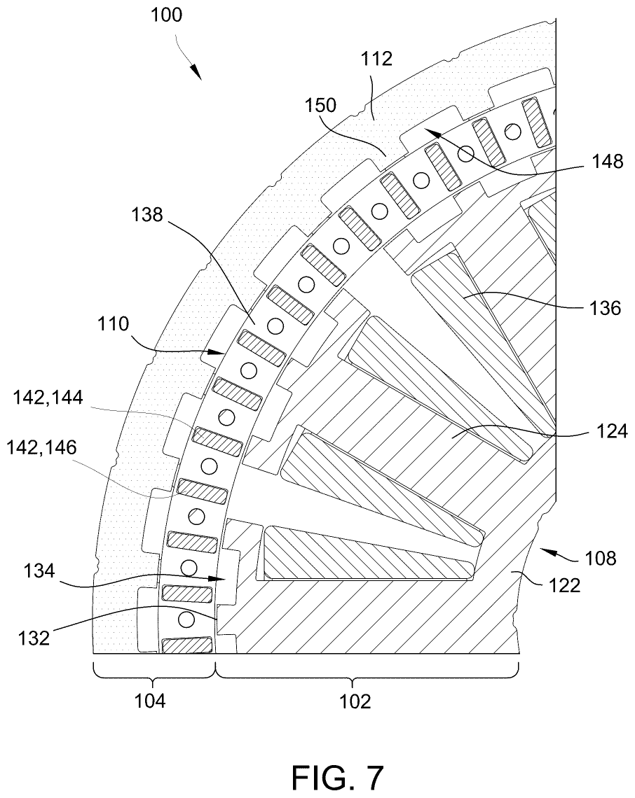

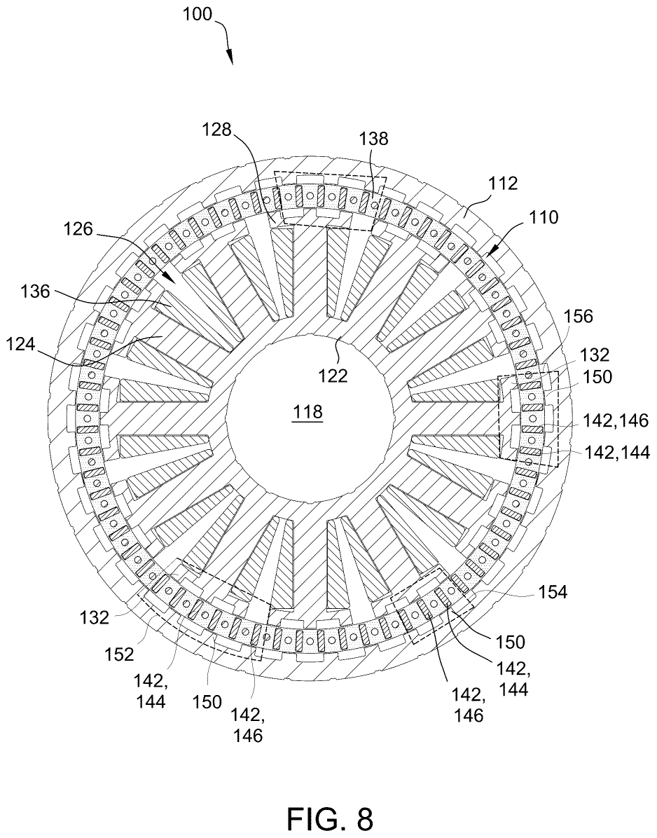

FIG. 3 is a cross-sectional front view of stator assembly 102 of motor assembly 100 taken along line CS-CS of FIG. 1, and FIG. 4 is an enlarged view of a portion of stator assembly 102 shown in FIG. 3. As discussed herein, stator 108 includes a plurality of sections and/or portions. For example, stator 108 includes an inner portion 122 including aperture 106 extending axially there through. That is, inner portion 122 is the radially inner-most portion of stator 108 and is radially opposite rotor assembly 104 of motor assembly 100 (see, FIGS. 7 and 8). During assembly, shaft 20 extends through aperture 106 and/or is coupled to inner portion 122 of stator 108.

Stator 108 also includes a plurality of arm portions 124 extending radially from inner portion 122. That is, a plurality of arm portions 124 are positioned circumferentially around and extend radially from inner portion 122 and opposite aperture 106. As shown in FIG. 3, each of the plurality of arm portions 124 are also circumferentially spaced apart from one another when extending radially from inner portion 122, and radially toward rotor assembly 104 (see, FIGS. 7 and 8). In non-limiting examples, each of the plurality of arm portions 124 are circumferentially spaced apart from one another equidistant. As a result, a plurality of openings 126 are formed between each of the plurality of arm portions 124. More specifically, each opening 126 is formed between two, circumferentially adjacent arm portions of the plurality of arm portions 124 of stator 108. As discussed herein, openings 126 included in stator 108 receive at least a portion of coils included in stator assembly 102. In the exemplary embodiment shown in FIG. 3, stator 108 includes twelve (12) arm portions 124 radially extending from inner portion 122. However, it is to be understood that stator 108 of stator assembly 102 can include more or less arm portions 124.

Additionally, and as shown in FIG. 3, stator 108 also includes a plurality of outer portions 128 radially opposite inner portion 122. Each outer portion 128 of stator 108 is disposed directly adjacent one of the plurality of arm portions 124. More specifically, a single outer portion 128 of the plurality of outer portions 128 is disposed directly adjacent to and radially outward from a corresponding, single arm portion 124 of the plurality of arm portions 124 for stator 108. As such, each arm portion 124 is positioned radially between inner portion 122 of stator 108 and a corresponding outer portion 128. Within motor assembly 100, each of the plurality of outer portions 128 of stator 108 is also positioned radially adjacent and/or radially inward rotor core 110 of rotor assembly 104 (see, FIGS. 7 and 8).

Each outer portion 128 also extends substantially perpendicular to corresponding arm portions 124 extending radially from inner portion 122. Segments 130 of each outer portion 128 also circumferentially extend over at least a portion of openings 126 formed between two adjacent openings 126 of stator 108. As discussed herein, segments 130 of outer portions 128 are disposed and/or positioned radially outward from openings 126. Each outer portion 128 is also substantially concentric with inner portion 122 and/or aperture 106 of stator 108. The number of outer portions 128 of stator 108 is equal to the number of arm portions 124. For example, stator 108 includes twelve (12) outer portions 128. However, it is to be understood that stator 108 of stator assembly 102 can include more or less outer portions 128.

The plurality of outer portions 128 of stator 108 also include a plurality of stator subteeth 132. In the non-limiting example shown in FIG. 3, the plurality of stator subteeth 132 extend radially from an exposed surface 134 of each of the plurality of outer portions 128 of stator 108. More specifically, each of the plurality of stator subteeth 132 extend radially outward from exposed surface 134 of outer portion 128, and/or radially away from arm portions 124 and/or inner portion 122, respectively. Each of the plurality of stator subteeth 132 extending radially from exposed surface 134 of outer portions 128 are also positioned radially adjacent and/or radially inward from rotor core 110 of rotor assembly 104 (see, FIGS. 7 and 8) during operation of motor assembly 100. In the non-limiting example shown in FIG. 3, each outer portion 128 of stator 108 includes three (3) distinct stator subteeth 132 extending radially therefrom. However, it is to be understood that stator 108 of stator assembly 102 can include more or less stator subteeth 132. As discussed herein, the number of subteeth 132 included within stator assembly 102, at least in part, determine a number of magnets included in rotor core 110 of rotor assembly 104.

Briefly turning to FIG. 4, each of the plurality of stator subteeth 132 included on and/or extending radially from outer portion 128 of stator 108 are equally spaced apart from one another. That is, each of the plurality of stator subteeth 132 are circumferentially spaced apart from one another on each of the plurality of outer portions 128 of stator 108 at a first distance (D1). Additionally, circumferentially adjacent stator subteeth 132 extending radially from distinct outer portions 128 of stator 108 are also separated from one another by the first circumferential distance (D1). For example, and as shown in FIG. 4, stator subtooth 132A extending from outer portion 128A of stator 108 is circumferentially spaced apart and/or separated from stator subtooth 132B extending from outer portion 128B by the first distance (D1). Outer portions 128, and more specifically segments 130 of outer portions 128, extend circumferentially and/or are sized to ensure the distance between stator subteeth 132 of adjacent, distinct outer portions 128 are equal to the distance between adjacent stator subteeth 132 included on a single or same outer portion 128 (e.g., first circumferential distance (D1)).

As shown in the non-limiting example of FIGS. 3 and 4, stator 108 is formed as a single, integral component. More specifically, stator 108 and its various portions (e.g., inner portion 122, arm portions 124, outer portions 128, stator subteeth 132, and so on) are formed as a single, unitary component. In other non-limiting examples, stator 108 is formed from a plurality of distinct portions that are coupled, bonded, attached, and/or matted together to form stator 108. Additionally, stator 108 and its various portions are formed from any suitable magnetic material and/or material including magnetic properties to allow or facilitate magnetic flux to flow therethrough. For example, stator 108 and portions (e.g., inner portion 122, arm portions 124, outer portions 128, stator subteeth 132, and so on) included therein are formed from laminated steel.

In the non-limiting example shown in FIGS. 3 and 4, stator assembly 102 also includes a plurality of coils 136 disposed within the plurality of openings 126 of stator 108. More specifically, each of the plurality of coils 136 (or windings) envelop one of the plurality of arm portions 124 of stator 108 and extend axially through two adjacent openings 126 positioned on either circumferential side of the corresponding arm portion 124. Each of the plurality of coils 136 are formed from electrically conductive wire material (e.g., copper) that is wound and/or wrapped around each of the plurality of arm portions 124 of stator 108. Additionally as shown, each of the plurality of coils 136 of stator assembly 102 are also radially disposed and/or positioned between inner portion 122 and outer portion 128 of stator 108. As shown in FIGS. 3 and 4, segments 130 of each of the plurality of outer portions 128 of stator 108 extend and/or are positioned radially outward from at least a portion of coil 136 enveloping the corresponding arm portion 124.

In non-limiting examples, coil 136 includes a single coil enveloping arm portions 124 of stator 108, or alternatively, coil 136 of motor assembly 100 includes a predefined, number of repeats included therein. The predefined, number of repeats is determined and/or defined by the phase windings or system for coil 136. The phase system, and in turn the number of repeats for coil 136 included in motor assembly 100 is predetermined and/or based on characteristics of motor assembly 100 including, but not limited to, the number of arm portions 124 included in stator 108, the size of motor assembly 100, and the like. Additionally, the repeats for coil 136 refer to the number of times a group of coils are repeated within stator 108. For example, in a three (3) phase system, the number of coils 136 included in the group and/or number of repeats is three (3), where each one of the coils in each group of coils 136 is powered by a distinct phase of the three phase system, as discussed herein. As discussed herein, the predefined, number of repeats for coil 136 influences, at least in part, the number of magnets included in rotor core 110 of rotor assembly 104. In the non-limiting shown in FIGS. 3 and 4, as well as FIG. 8 discussed herein, stator assembly 102 includes a three phase system. As such, coils 136 of stator assembly 102 include four (4) repeats. However, it is to be understood that stator assembly 102 can include any suitable phase system, and as such, any corresponding number of repeat.

During operation, and as discussed herein, electrical currents are passed through coils 136 of stator assembly 102. As current is applied to coils 136, electrical flux flows to the stator 108, and the magnetic flux, as it is applied to rotor core 110 through stator subteeth 132 and modulator 112, respectively, causes rotor core 110 of rotor assembly 104 to rotate.

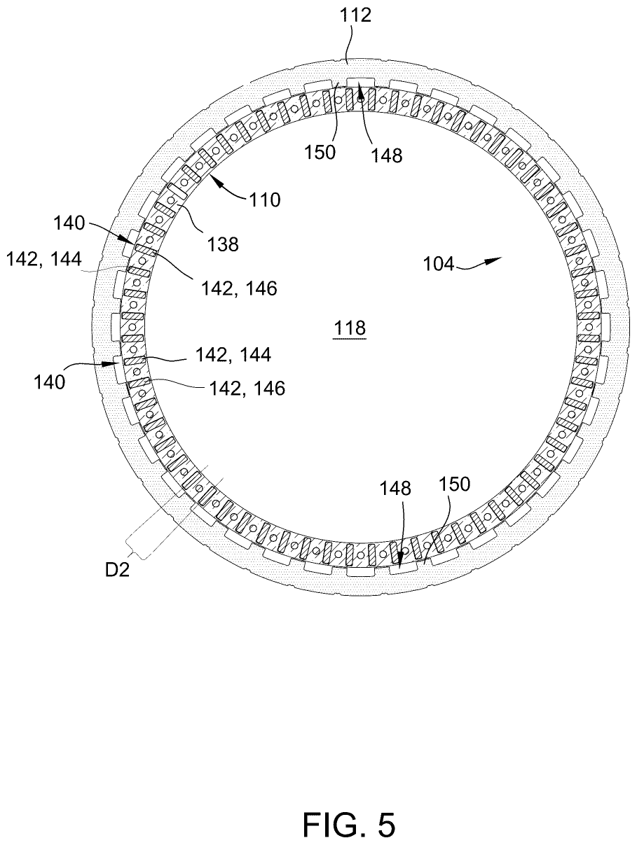

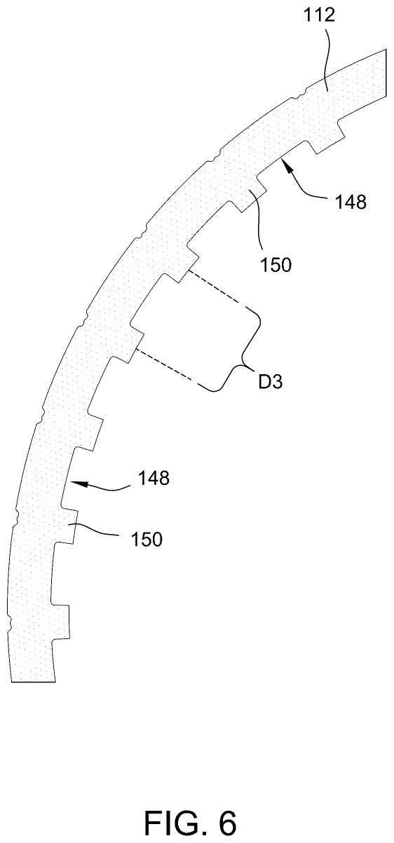

FIG. 5 is a cross-sectional front view of rotor assembly 104 and modulator 112, respectively, of motor assembly 100 taken along line CS-CS of FIG. 1, and FIG. 6 is an enlarged view of a portion of modulator 112 shown in FIG. 5. Rotor core 110 of rotor assembly 104 for motor assembly 100 (see, FIG. 2) includes a rotor support structure 138 that substantially surrounds and/or encompasses stator 108 of stator assembly 102 within motor assembly 100 (see, FIGS. 2, 7, and 8). In non-limiting examples, rotor support structure 138 includes a plurality of slots 140 extending axially therethrough. Each of the plurality of slots 140 is circumferentially spaced equidistant apart from one another about rotor support structure 138. As discussed herein, each slot 140 formed axially through rotor support structure 138 is configured to receive one or more magnets such that each magnet is embedded in rotor support structure 138. In the exemplary embodiment, slots 140 of rotor support structure 138 are generally rectangular. Alternatively, the plurality of slots 140 formed through and/or within rotor support structure 138 have any suitable shape corresponding to the shape of the permanent magnets that enable operation of motor assembly 100, as described herein. Rotor support structure 138 is formed from any suitable magnetic material and/or material including magnetic properties. For example, rotor support structure 138 is formed from laminated steel.

Rotor core 110 also includes a plurality of magnets 142 positioned within rotor support structure 138. More specifically, and as shown in FIG. 5, a plurality of magnets 142 are positioned within, disposed in, and/or extend axially through the plurality of slots 140 formed in rotor support structure 138. Each of the plurality of magnets 142 positioned within rotor support structure 138 are circumferentially spaced equidistant apart from one another within rotor support structure 138. For example, and as shown in FIG. 5, any two circumferentially adjacent magnets of the plurality of magnets 142 are spaced apart from one another at a second circumferential distance (D2). In other non-limiting examples (not shown), the distance between two adjacent magnets 142 included in rotor support structure 138 of rotor assembly 104 various throughout rotor support structure 138. In the exemplary embodiment, magnets 142 are rare earth magnets magnetized in a direction perpendicular to the axis of rotation R (see, FIGS. 1 and 2). However, it is to be understood that the plurality of magnets 142 included in rotor core 110 may be fabricated from any suitable material that enables motor assembly 100 to function as described herein, for example, bonded neodymium, AlNiCo, sintered neodymium, bonded and ceramic ferrite, and/or samarium cobalt.

In the non-limiting example shown in FIG. 5, the plurality of magnets 142 include a first set of magnets 144 having a first polarity, and a second set of magnets 146 having a second polarity, distinct from the first polarity of the first set of magnets 144. The first set of magnets 144 is alternately spaced with the second set of magnets 146 within rotor support structure 138 of rotor core 110. That is, the first set of magnets 144 and the second set of magnets 146 forming the plurality of magnets 142 are alternately spaced within rotor support structure 138, such that any two circumferentially adjacent magnets 142 include a single magnet from the first set of magnets 144 and a single magnet form the second set of magnets 146.

As shown in FIG. 5, and as discussed herein, modulator 112 substantially surrounds and/or encompasses rotor core 110 of rotor assembly 104 within motor assembly 100 (see, FIGS. 2, 7, and 8). Modulator 112 includes an inner surface 148 disposed adjacent rotor core 110. More specifically, modulator 112 includes inner surface 148 that is radially adjacent and/or radially outward from rotor support structure 138 and the plurality of magnets 142 forming rotor core 110 of rotor assembly 104. As discussed herein, modulator 112 remains stationary during the operation of motor assembly 100, such that rotor core 110 is configured to rotate relative to modulator 112, as well as stator 108 of stator assembly 102.

In the non-limiting example shown in FIGS. 5 and 6, the plurality of modulator subteeth 150 extend radially inward from inner surface 148 of modulator 112 and/or radially toward rotor support structure 138 and/or the plurality of magnets 142 of rotor core 110. In the non-limiting example shown in FIG. 5, modulator 112 includes thirty-six (36) distinct modulator subteeth 150. However, it is to be understood that modulator 112 can include more or less modulator subteeth. As discussed herein, the number of modulator subteeth 150 included within and/or on modulator 112, at least in part, determine a number of magnets 142 included in rotor core 110 of rotor assembly 104.

Briefly turning to FIG. 6, each of the plurality of modulator subteeth 150 are equally spaced apart from one another. That is, each of the plurality of modulator subteeth 150 are circumferentially spaced apart from one another on modulator 112 at a third distance (D3). As discussed herein, in non-limiting examples, the third circumferential distance (D3) separating each of the plurality of modulator subteeth 150 on modulator 112 may be substantially equal to the first circumferential distance (D1) separating each of the plurality of stator subteeth 132 of stator 108.

As shown in the non-limiting example of FIGS. 5 and 6, modulator 112 is formed as a single, integral component. More specifically, modulator 112 and subteeth 150 extending radially therefrom are formed as a single, unitary component. In other non-limiting examples, modulator 112 is formed from a plurality of distinct portions that are coupled, bonded, attached, and/or matted together to form modulator 112. Additionally, modulator 112 and modulator subteeth 150 are formed from any suitable magnetic material and/or material including magnetic properties to allow or facilitate magnetic flux to flow therethrough. For example, modulator 112 and modulator subteeth 150 extending radially therefrom are formed from laminated steel.

FIGS. 7 and 8 show enlarged, cross-sectional front views of at least a portion of motor assembly 100 taken along line CS-CS of FIG. 1. It is understood that similarly numbered and/or named components may function in a substantially similar fashion. Redundant explanation of these components has been omitted for clarity.

FIG. 7 shows an enlarged, cross-sectional front view of a portion of stator assembly 102, rotor assembly 104, and modulator 112 forming motor assembly 100. As shown in the non-limiting example, and as discussed herein, the plurality of stator subteeth 132 extend radially outward from each outer portion 128 and radially toward and/or adjacent rotor core 110 of rotor assembly 104. Additionally, rotor core 110 including rotor support structure 138 and the plurality of magnets 142 is positioned radially outward from, adjacent to, and circumscribes stator 108 of stator assembly 102. Rotor core 110 is also radially disposed between modulator 112 and stator 108 of stator assembly 102. During operation, and as discussed herein, as current is applied to coils 136 of stator assembly 102, electrical flux flows to the stator 108, and the magnetic flux, as it is applied to rotor core 110 through stator subteeth 132 and modulator subteeth 150 of modulator 112, respectively, causes rotor core 110 of rotor assembly 104 to rotate with respect to stationary stator 108 and stationary modulator 112.

Additionally as shown in FIG. 7, the plurality of modulator subteeth 150 of modulator 112 are circumferentially staggered with the plurality of stator subteeth 132 of stator 108 for stator assembly 102. That is, each of the plurality of modulator subteeth 150 of modulator 112 are radially offset and/or not in radial alignment with the plurality of stator subteeth 132 of stator 108. In the non-limiting example, the plurality of modulator subteeth 150 of modulator 112 are radially aligned midway and/or circumferentially equidistant between two adjacent stator subteeth 132 of stator 108. Additionally, and as shown in FIG. 7, one of the plurality of modulator subteeth 150 of modulator 112 is also radially aligned between two adjacent outer portions 128 of stator 108 and/or circumferentially equidistant between two adjacent stator subteeth 132 on distinct outer portions 128 of stator 108. Moreover, the plurality of stator subteeth 132 of stator 108 are also radially aligned midway and/or circumferentially equidistant between two adjacent modulator subteeth 150 of modulator 112. The equidistant, circumferential staggering of the plurality of stator subteeth 132 and the plurality of modulator subteeth 150 within motor assembly 100 improves operation, and more specifically the flow of magnetic flux, between stator 108, rotor core 110, and modulator 112, respectively, during operation.

FIG. 8 shows a cross-sectional front view of the entirety of motor assembly 100 including stator assembly 102, rotor assembly 104, and modulator 112. In the non-limiting example, rotor support structure 138 and the plurality of slots 140 formed therethrough are configured and/or formed such that only distinct portions or groupings of the plurality of magnets 142 are substantially, radially aligned with stator subteeth 132 and/or modulator subteeth 150 during an instance of operation of motor assembly 100. Additionally, the remaining portion or groupings of the plurality of magnets 142 are not substantially aligned with and/or are positioned substantially, circumferentially between stator subteeth 132 and/or modulator subteeth 150 during the instance of operation of motor assembly 100.

For example, FIG. 8 shows motor assembly 100 in an instance of operation where rotor core 110 is rotating relative to stator 108 and modulator 112, respectively. In the non-limiting example, a first grouping 152 of the plurality of magnets 142 are identified. First grouping 152 of the plurality of magnets 142 includes a predetermined number (e.g., three (3)) of the first set of magnets 144 included in rotor core 110 that are substantially radially aligned with a proportion or some of the plurality of stator subteeth 132 of stator 108 during an instance of operation of motor assembly 100. Additionally, first grouping 152 of the plurality of magnets 142 includes a predetermined number (e.g., three (3)) of the second set of magnets 146 included in rotor core 110 that are substantially radially aligned with a proportion or some of the plurality of modulator subteeth 150 of modulator 112 during an instance of operation of motor assembly 100. In the example shown, first grouping 152 of the plurality of magnets 142 includes six (6) circumferentially adjacent and alternating magnets of the first set of magnets 144 and the second set of magnets 146, respectively.

Additionally in the non-limiting example, a second grouping 154 of the plurality of magnets 142 includes a predetermined number (e.g., three (3)) of the first set of magnets 144 included in rotor core 110 that are substantially radially aligned with a proportion or some of the plurality of modulator subteeth 150 of modulator 112 during an instance of operation of motor assembly 100. Second grouping 154 of the plurality of magnets 142 also includes a predetermined number (e.g., three (3)) of the second set of magnets 146 included in rotor core 110 that are substantially radially aligned with a proportion or some of the plurality of stator subteeth 132 of stator 108 during an instance of operation of motor assembly 100. Similar to first grouping 152, second grouping 154 of the plurality of magnets 142 includes six (6) circumferentially adjacent and alternating magnets of the first set of magnets 144 and the second set of magnets 146, respectively.

Although discussed herein as including six (6) circumferentially adjacent and alternating magnets of the plurality of magnets 142, it is to be understood that the identified groupings of the plurality of magnets 142 that are radially aligned with subteeth 132, 150 of motor assembly 100 can be any predetermined number. Although a single, first grouping 152 and single second grouping 154 of the plurality of magnets 142 is identified in FIG. 8, it is understood that rotor core 110 can include a plurality of groupings of magnets 142 that are also substantially radially aligned with modulator subteeth 150 of modulator 112 and/or stator subteeth 132 of stator 108, respectively, during an instance of operation of motor assembly 100. However, it is to be understood that not all of the plurality of magnets 142 are radially aligned with modulator subteeth 150 of modulator 112 and/or stator subteeth 132 of stator 108, respectively, during an instance of operation of motor assembly 100. As discussed herein, the predetermined number of magnets included in the identified groupings (e.g., grouping 152, 154) of the plurality of magnets 142 is based on, at least in part, the number of the plurality of magnets 142 included in rotor core 110, the number of stator subteeth 132 of stator 108, and/or the number of modulator subteeth 150 of modulator 112.

At least a third or distinct grouping 156 of the plurality of magnets 142 are not radially aligned with either a proportion of stator subteeth 132 of stator 108 nor modulator subteeth 150 of modulator 112. That is, distinct grouping 156 includes a predetermined number (e.g., two (2)) of the first set of magnets 144 included in rotor core 110 that are substantially circumferentially offset from and/or radially disposed between both a proportion of modulator subteeth 150 of modulator 112 and a proportion of stator subteeth 132 of stator 108, respectively, during an instance of operation of motor assembly 100. Additionally, distinct grouping 156 includes a predetermined number (e.g., two (2)) of the second set of magnets 146 included in rotor core 110 that are also substantially circumferentially offset from and/or radially disposed between both a proportion of modulator subteeth 150 of modulator 112 and a proportion of stator subteeth 132 of stator 108, respectively, during an instance of operation of motor assembly 100. Although a single, distinct grouping 156 of the plurality of magnets 142 is identified in FIG. 8, it is to be understood that rotor core 110 includes a plurality of groupings of magnets 142 that are also substantially circumferentially offset from and/or radially disposed between both a proportion of modulator subteeth 150 of modulator 112 and a proportion of stator subteeth 132 of stator 108, respectively, during an instance of operation of motor assembly 100. As discussed herein, the predetermined number of magnets included in the distinct groupings (e.g., grouping 156) of the plurality of magnets 142 is based on, at least in part, the number of the plurality of magnets 142 included in rotor core 110, the number of stator subteeth 132 of stator 108, and/or the number of modulator subteeth 150 of modulator 112.

Including distinct groupings 152, 154, 156 within motor assembly 100 reduces noise and/or undesirable movement of rotor core 110 (referred herein as “ripple”) during operation. That is, by including only a portion or grouping of the plurality of magnets 142 that are radially aligned with stator subteeth 132 and/or modulator subteeth 150 during an instance of operation, rotor core 110 rotates about stator 108 with increased uniformity, and reduces uneven magnet pull or flux in certain areas of motor assembly 100, which in turn causes the undesirable ripple effect and noise during operation.

In addition to the circumferential spacing of the plurality of magnets 142, the number of magnets 142 included in rotor core 110 facilitate achieving the improved operation of motor assembly 100. As discussed herein, the number of magnets 142 included in rotor core 110 is based on, at least in part, the number of stator subteeth 132, the number of modulator subteeth 150, and the predefined, number of repeats for coil 136. More specifically, and in non-limiting examples, the number of magnets 142 included in rotor core 110 is a calculated range based on, at least in part, the number of stator subteeth 132, the number of modulator subteeth 150, and the predefined, number of repeats for coil 136. Example equations for calculating the range of number of magnets 142 to include in rotor core 110 are:

$$( ( \frac{\# of stator subteeth + \# of modulator subteeth}{\# of repeats ( coil )} ) - 2 ) * \# of repeats ( coil ) \qquad ( 1 )$$

$$( ( \frac{\# of stator subteeth + \# of modulator subteeth}{\# of repeats ( coil )} ) + 2 ) * \# of repeats ( coil ) \qquad ( 2 )$$

where the equation (1) represents the lower limit of the calculated number of magnets 142 to be included within rotor core 110, and equation (2) represents the upper limit of the calculated number of magnets 142 to be included within rotor core 110. With reference to the non-limiting example shown in FIG. 8, where stator assembly 102 includes thirty-six (36) stator subteeth 132, thirty-six (36) modulator subteeth 150, and four (4) repeats for coil 136, the example equations include:

$$( ( \frac{36 + 36}{4} ) - 2 ) * 4 = 64 magnets \qquad ( 1 )$$

$$( ( \frac{36 + 36}{4} ) + 2 ) * 4 = 80 magnets \qquad ( 2 )$$

As shown in FIG. 8, rotor core 110 includes sixty-four (64) magnets 142 within rotor core 110. In another non-limiting example, rotor core 110 can include up to eighty (80) magnets 142 within rotor core 110. Alternatively, rotor core 110 of rotor assembly 104 can include any even number of magnets 142 between sixty-four (64) and eighty (80) during operation of motor assembly 100.

It is to be understood that motor assembly 100 may operate with more or less magnets 142 included within rotor core 110 of rotor assembly 104 than the number determined by equations (1) and (2) defined herein. However, rotor core 110 including a number of magnets 142 outside of the lower or upper limit defined by equations (1) and (2) may increase the noise and/or ripple effect during operation, and/or may operate at a reduced efficiency than those motor assemblies 100 including rotor cores 110 having a number of magnets 142 equal to or within the lower or upper limit defined by equations (1) and (2), defined herein.

As discussed herein, motor assembly 100, and more specifically stator assembly 102, rotor assembly 104, and modulator 112, can include a distinct number of features. For example (not shown), stator 108 of stator assembly 102 includes nine (9) arm portions 124 extending radially from inner portion 122, and nine (9) outer portions 128 extending from arm portions 124. Additionally in the example (not shown), each outer portion 128 of stator 108 includes four (4) stator subteeth 132 extending radially outward and/or radially therefrom. The predefined, number of repeats for coils 136 including in stator assembly 102 is also determined and/or defined as three (3) repeats. Finally, modulator 112 includes thirty-six modulator subteeth 150 extending radially inward from inner surface 148 and/or toward rotor core 110.

Using equation (1) defined herein, the lower limit for the number of magnets 142 included in rotor core 110 of motor assembly 100 in the distinct example (not shown) is equal to sixty-six (66) magnets 142. Additionally in non-limiting examples (not shown), rotor core 110 can include up to (e.g., upper limit, equation (2)) seventy-eight (78) magnets 142.

Exemplary embodiments of rotor assemblies and stator assemblies for electric motor assemblies and systems are described above in detail. The motor assembly and its components are not limited to the specific embodiments described herein, but rather, components of the systems may be utilized independently and separately from other components described herein. For example, the components may also be used in combination with other motor systems, methods, and apparatuses, and are not limited to practice with only the systems and apparatus as described herein. Rather, the exemplary embodiments can be implemented and utilized in connection with many other applications.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A flux reversing motor assembly, comprising:
a rotor assembly including:
a rotor core including:
a rotor support structure; and
a plurality of magnets positioned within said rotor support structure, each of said plurality of magnets circumferentially spaced apart from one another within said rotor support structure; and
a modulator surrounding said rotor core of said rotor assembly, said modulator including:
an inner surface disposed adjacent said rotor core; and
a plurality of modulator subteeth extending radially from said inner surface and toward said rotor core,
wherein said rotor core of said rotor assembly is configured to rotate relative to said modulator.

2. The flux reversing motor assembly of claim 1, wherein a first grouping of said plurality of magnets of said rotor core are radially aligned with a proportion of said plurality of modulator subteeth of said modulator.

3. The flux reversing motor assembly of claim 2, wherein a second grouping of said plurality of magnets of said rotor core are not radially aligned with a proportion of said plurality of modulator subteeth of said modulator.

4. The flux reversing motor assembly of claim 1, wherein each of said plurality of modulator subteeth are circumferentially spaced apart from one another and equidistant from one another on said inner surface of said modulator.

5. The flux reversing motor assembly of claim 1, wherein said plurality of magnets of said rotor core include:
a first set of magnets having a first polarity; and
a second set of magnets having a second polarity, distinct from said first polarity of said first set of magnets,
wherein said first set of magnets is alternately spaced with said second set of magnets within said rotor support structure of said rotor core.

6. The flux reversing motor assembly of claim 1, wherein a number of said plurality of magnets of said rotor core is based on a number of said plurality of modulator subteeth of said modulator.

7. A stator assembly for use in a flux reversing motor assembly, the stator assembly comprising:
a stator including:
an inner portion including an aperture extending axially there through;
a plurality of arm portions extending radially from said inner portion, each of said plurality of arm portions circumferentially spaced from one another to form a plurality of openings; and
a plurality of outer portions radially opposite said inner portion, each of said plurality of outer portions disposed directly adjacent one of said plurality of arm portions and including a plurality of stator subteeth; and
a plurality of coils disposed within the plurality of openings of said stator, each of said plurality of coils surrounding one of said plurality of arm portions of said stator, radially between said inner portion and said plurality of outer portions.

8. The stator assembly of claim 7, wherein said plurality of stator subteeth extend from a surface of each of said plurality of outer portions of said stator radially toward a rotor core of the flux reversing motor assembly.

9. The stator assembly of claim 8, wherein a number of a plurality of magnets of the rotor core is based on a number of said plurality of stator subteeth of said stator.

10. The stator assembly of claim 7, wherein each of said plurality of stator subteeth are circumferentially spaced from one another on each of said plurality of outer portions of said stator.

11. A motor assembly comprising:
a rotor assembly including:
a rotor core including a plurality of magnets positioned within a rotor support structure;
a modulator surrounding said rotor core, said modulator including a plurality of modulator subteeth extending radially from an inner surface disposed adjacent said rotor core of said rotor assembly and extending radially toward said rotor core; and
a stator assembly radially inward from said rotor assembly, said stator assembly including:
a stator radially inward from and adjacent said rotor core of said rotor assembly, said stator including:
a plurality of arm portions extending radially from an inner portion of said stator, each of said plurality of arm portions circumferentially spaced from one another to form a plurality of openings; and
a plurality of outer portions radially opposite the inner portion, and adjacent said rotor core of said rotor assembly, each of said plurality of outer portions disposed directly adjacent one of said plurality of arm portions and including a plurality of stator subteeth,
wherein said rotor core is configured to rotate relative to said modulator and said stator.

12. The motor assembly of claim 11, wherein said stator assembly further includes a plurality of coils disposed within the plurality of openings of said stator, each of said plurality of coils surrounding one of said plurality of arm portions of said stator, radially between the inner portion and said plurality of outer portions of said stator.

13. The motor assembly of claim 11, wherein said plurality of magnets include:
a first set of magnets having a first polarity; and
a second set of magnets having a second polarity, distinct from said first polarity of said first set of magnets,
wherein said first set of magnets is alternately spaced with said second set of magnets within the rotor support structure of said rotor core.

14. The motor assembly of claim 13, wherein a first grouping of said plurality of magnets includes:
a predetermined number of said first set of magnets of said rotor core radially aligned with a proportion of said plurality of the stator subteeth of said stator; and
a predetermined number of said second set of magnets radially aligned with a proportion of said plurality of the modulator subteeth.

15. The motor assembly of claim 14, wherein a second grouping of said plurality of magnets includes:
a predetermined number of said first set of magnets are radially aligned with a distinct proportion of said plurality of modulator subteeth; and
a predetermined number of said second set of magnets are radially aligned with a distinct proportion of said plurality of stator subteeth.

16. The motor assembly of claim 15, wherein a third grouping of said plurality of magnets includes:
a predetermined number of said first set of magnets not radially aligned with any of said plurality of modulator subteeth and any of said plurality of stator subteeth; and
a predetermined number of said second set of magnets not radially aligned with any of said plurality of modulator subteeth and any of said plurality of stator subteeth.

17. The motor assembly of claim 11, wherein said plurality of modulator subteeth are circumferentially staggered with said plurality of stator subteeth.

18. The motor assembly of claim 11, wherein each of said plurality of modulator subteeth are circumferentially spaced from one another and equidistant from one another on the inner surface of said modulator.

19. The motor assembly of claim 11, wherein each of said plurality of stator subteeth are circumferentially spaced from one another on each of said plurality of outer portions of said stator.

20. The motor assembly of claim 11, wherein a number of said plurality of magnets is based on:
a number of said plurality of modulator subteeth; and
a number of said plurality of stator subteeth.
